(19) United States
(12) Patent Application Publication
(10) Pub. No.: US 2019/0312646 A1
(43) Pub. Date: Oct. 10, 2019

(54) OPTICAL COMMUNICATION WITH WAVELENGTH-DEPENDENT AMPLITUDE PRE-COMPENSATION

(71) Applicant: Mark Peter Earnshaw, Berkeley Heights, NJ (US)

(72) Inventor: Mark Peter Earnshaw, Berkeley Heights, NJ (US)

(21) Appl. No.: 16/371,750

(22) Filed: Apr. 1, 2019

Related U.S. Application Data
(60) Provisional application No. 62/653,551, filed on Apr. 5, 2018.

(51) Int. Cl. H04B 10/54; H04J 14/02; H04B 10/25; H04B 10/50; H04B 10/58

(52) U.S. Cl. CPC H04B 10/54; H04J 14/02; H04B 10/58; H04B 10/503; H04B 10/25

(57) ABSTRACT

An apparatus includes an optical source to produce light in a sequence of wavelength-channels, an optical transmission fiber connected to receive said produced light, an optical wavelength-demultiplexer optically coupled to the optical transmission fiber, and an array of optical data modulators. Each of the optical data modulators is optically coupled to receive light of a corresponding one of the wavelength-channels from the optical source via the optical transmission fiber and the optical wavelength-demultiplexer. The optical source is configured to transmit said light to said optical transmission fiber with a wavelength-dependent intensity.

This application claims the benefit of U.S. provisional patent application No. 62/653,551, filed on Apr. 5, 2018, by Mark P. Earnshaw.

### BACKGROUND

### Technical Field

The invention relates to optical fiber communications apparatus and methods of use thereof.

### Related Art

This section introduces aspects that may be help to facilitate a better understanding of the inventions. Accordingly, the statements of this section are to be read in this light and are not to be understood as admissions about what is prior art or what is not prior art.

In optical fiber communication, wavelength division multiplexing (WDM) has been an important method for increasing the data capacity of an optical fiber. WDM has also stimulated the development of various wavelength selective apparatus such as wavelength-channel based optical switches, optical add-drop multiplexers, optical cross-connects, and wavelength-channel-based optical wavelength-multiplexers and optical wavelength-demultiplexers. WDM has also stimulated a development of optical amplifiers over broad wavelength bands.

### SUMMARY OF SOME ILLUSTRATIVE EMBODIMENTS

Presently, WDM optical amplifiers typically have low wall plug power efficiencies. The inventor believes that some embodiments may improve the wall plug power efficiencies of some such optical amplifiers to greater than 10 percent and possibly to even greater than 20 percent. In such embodiments, the optical amplifiers are pre-amplifiers for optical sources of multi-wavelength-channel carrier light, which may also have wavelength-dependent intensity pre-compensation.

In some embodiments, an apparatus includes an optical source to produce light, e.g., temporally in parallel, in a sequence of wavelength-channels, an optical transmission fiber connected to receive said produced light, an optical wavelength-demultiplexer optically coupled to the optical transmission fiber, and an array of optical data modulators. Each of the optical data modulators is optically coupled to receive light of a corresponding one of the wavelength-channels from the optical source via the optical transmission fiber and the optical wavelength-demultiplexer. The optical source is configured to transmit said light to said optical transmission fiber with a wavelength-dependent intensity.

In some such embodiments of the apparatus, the wavelength-dependent intensity may be largest for one of the wavelength channels near an edge of a wavelength range for the sequence of wavelength-channels. The wavelength-dependent intensity may even be largest for wavelength-channels near one or both edges of the wavelength range.

In any of the above embodiments, the apparatus may further include an array of optical data receivers, wherein an optical fiber couples to the array of optical data receivers via a second optical wavelength-demultiplexer and couples to the array of optical data modulators via an optical wavelength-multiplexer. In some such embodiments, the optical fiber coupled to the array of optical data receivers via the second optical wavelength-demultiplexer is the same optical transmission fiber. In any embodiments of this paragraph, light received at the array of optical data receivers may have a substantially flat wavelength-channel dependent intensity. In any embodiments of this paragraph, the optical source may be configured to substantially or, at least, partially, pre-compensate for wavelength-dependent optical attenuation between the optical source and the array of optical data receivers.

In any of the above embodiments, the apparatus may further include an optical amplifier located to amplify light output from the optical source and transmit said amplified light to the optical transmission fiber with a wall plug power efficiency of greater than 10 percent or even possibly greater than 20 percent.

In any of the above embodiments with an optical amplifier, the optical amplifier may additionally share the multi-wavelength optical source among multiple transmission fiber links by splitting the power of the multi-wavelength optical source into separate portions and amplifying each such portion prior to transmission to the corresponding transmission fiber link.

In any of the above embodiments, the optical source may include an array of lasers optically connected to inputs of an optical wavelength-multiplexer. Each of the lasers may be configured to produce light of different wavelength-channel. Different ones of the lasers may be configured to be driven such that, at an output of the optical wavelength-multiplexer, the light of wavelength-channels near outer boundaries of the sequence may have a higher intensity than light of wavelength-channels away from the boundaries. Some such embodiments of this paragraph may further include an optical amplifier connected to amplify light output from the array of lasers and to transmit said amplified light to the optical transmission fiber with a wall plug power efficiency of greater than 10 percent or even possibly greater than 20 percent.

In any of the above embodiments, the apparatus may be a wavelength division multiplexing, optical communication system communicatively connecting digital data servers located inside a data center.

In some of the above embodiments, the optical data modulators may be configured to transmit data-modulated light to the optical transmission fiber.

In other embodiments, a method, includes, from a multi-wavelength optical source, transmitting to an optical transmission fiber light with a wavelength-dependent intensity to, at least, partially compensate for a wavelength-dependent optical attenuation between the multi-wavelength optical source and optical data receivers of an array. Each of said optical data receivers is connected via the optical transmission fiber to receive some light of a corresponding wavelength-channel of said transmitted light.

In some of the embodiments, the above method may further include, at each one of a plurality of optical data modulators, data modulating light received from the multi-wavelength optical source in a wavelength-channel corresponding to said one of the optical data modulators, wherein the optical data modulators of the plurality are connected to receive light from said multi-wavelength optical source via a same optical fiber.

In some of the embodiments of the method, each one of said optical data receivers may be connected to receive a portion of the data-modulated light from a different corresponding one of the optical data modulators, wherein the array of optical data modulators is connected to transmit the data-modulated light to a same optical fiber. In some such embodiments, the method may further include, at the optical source, adjusting a wavelength dependence of said intensity of transmitted light, at least, in part based on measurements of light intensities received at some of the optical data receivers.

In any of the embodiments of the method, the wavelength-dependent intensity of the transmitted light may be largest for one or both of the wavelength-channels near an edge of an interval including the sequence of wavelength-channels.

In any of the embodiments of the method, the wavelength-dependent intensity of the transmitted light may have maxima in the wavelength-channels near one or both edges of an interval including the sequence of wavelength-channels.

Various embodiments include methods of operating the above described embodiments of apparatus.

### BRIEF DESCRIPTION OF THE DRAWINGS

FIG. 1 is a block diagram schematically illustrating a WDM optical fiber communication system having a multi-wavelength optical source of carrier light;

FIG. 2 schematically illustrates the wavelength-dependence of light intensities at various positions in the WDM optical fiber communication system of FIG. 1;

FIG. 3 is a block diagram schematically illustrating an alternate WDM optical fiber communication system having a multi-wavelength optical source of carrier light; and

FIG. 4 is a flow chart schematically illustrating an example of a method of operating a WDM optical fiber communication system, e.g., the WDM optical fiber communication systems of FIGS. 1 and 3.

In the Figures, relative dimension(s) of some feature(s) may be exaggerated to more clearly illustrate the feature(s) and/or relation(s) to other feature(s) therein.

In the various Figures, similar reference numbers may be used to indicate similar structures and/or structures with similar functions.

Herein, various embodiments are described more fully by the Figures and the Detailed Description of Illustrative Embodiments. Nevertheless, the inventions may be embodied in various forms and are not limited to the embodiments described in the Figures and the Detailed Description of Illustrative Embodiments.

### DETAILED DESCRIPTION OF ILLUSTRATIVE EMBODIMENTS

An optical source cable of outputting light of different optical wavelength-channels, in parallel, is also often referred to as an optical comb source.

Some embodiments of the present application may be able to use some apparatus and/or methods disclosed in one or more of the below-listed U.S. patent applications:

U.S. application Ser. No. 15/946,161, filed Apr. 5, 2018, by Ting-Chen Hu et al;

U.S. application Ser. No. 15/946,061, filed Apr. 5, 2018, by Mark Earnshaw et al;

U.S. application No. Ser. 15/946,353, filed Apr. 5, 2018, by Yee Low et al; and

U.S. provisional application No. 62/653,152, filed Apr. 5, 2018, by David Neilson et al. Each of the above-listed U.S. applications is incorporated herein, by reference, in its entirety.

In a WDM optical fiber communication system various optical components can attenuate or amplify light of different wavelength-channels to different amounts. On the other hand, it may be desirable to have optical data receivers of light for different wavelength-channels to receive data-modulated optical carriers of about the same time-averaged intensity. For example, such received time-averaged intensities may desirably vary by less than about 3 decibels, less than about 2 decibels or even by less than about 1 decibel over an array of optical data receivers for the different WDM wavelength-channels. In such a situation, the different optical data receivers are more likely to have similar bit error rates during demodulation of data from the received data-modulated optical carriers without a need for individualization of such receivers or with a need of less complex individualization thereof.

In many situations, the overall energy efficiency of a system is often an important metric. Therefore, it may be advantageous to approximately minimize the optical power at each optical data receiver to be near a minimum required for obtaining an acceptable transmission bit error rate given the sensitivity of the optical data receiver. For this reason, it may be desirable to have optical data receivers of different optical wavelength-channels to receive data-modulated optical carriers of about the same time-averaged intensity.

The inventor believes that some WDM optical fiber communication systems may be improved by pre-compensating the intensity of multi-wavelength carrier light, in a wavelength-dependent manner, prior to its transmission to optical components that can cause wavelength-dependent optical attenuation and/or optical amplification, e.g., prior to transmission to an optical transmission fiber for carrying such WDM carrier light and possibly prior to transmission of such WDM carrier light to an optical pre-amplifier. Such wavelength-dependent intensity pre-compensation may lower undesired effects of accumulated wavelength-dependent optical attenuation.

Also, such pre-compensation may improve the efficiency of any optical pre-amplifier for multi-wavelength-channel light, e.g., when a multi-wavelength-channel data-modulated optical signal is transmitted between one optical data transmitter and one optical data receiver.

Indeed, such pre-compensation may be especially useful in WDM optical fiber communication systems, which are based on a multi-wavelength optical source whose power is distributed in a wavelength-dependent manner to optical data modulators for use in sets of optical communication paths that rarely change over time. Such sets of optical communication paths may be used, for example, in some types of intra-data center, optical fiber communication.

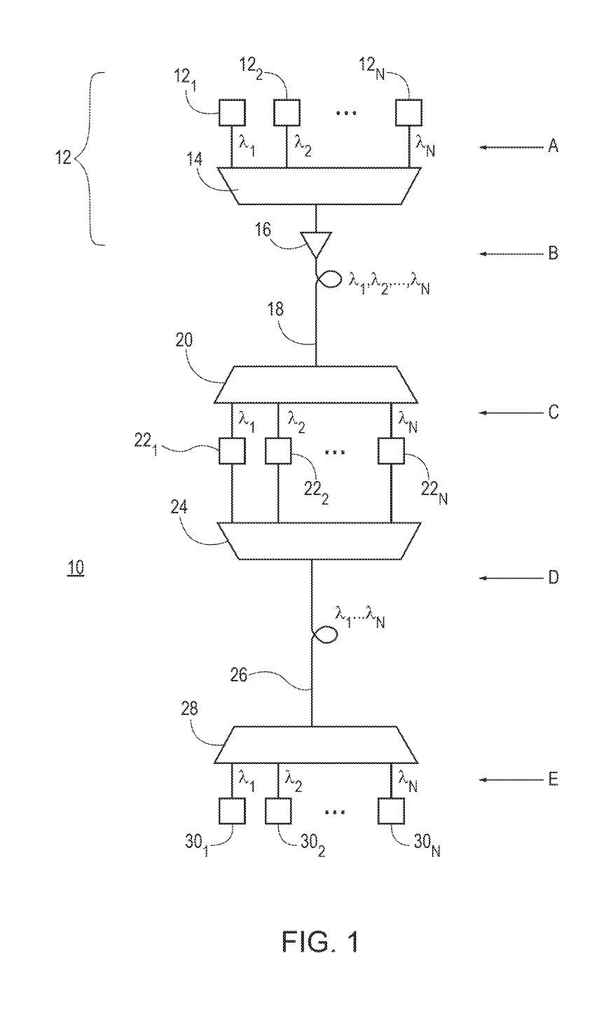

FIG. 1 illustrates a WDM optical fiber communication system 10, which is based on a multi-wavelength optical source 12 for carrier light in a sequence of N wavelength-channels λ₁, λ₂, . . . , λ_{N}. That is, the multi-wavelength optical source 12 is configured to output light of the N wavelength-channels λ₁-λ_{N} in parallel. The optical fiber communication system 10 also includes an array of optical data modulators 22₁, 22₂, . . . , 22_{N}.

As illustrated, the multi-wavelength optical source 12 may include, in some embodiments, N single wavelength-channel, light sources 12₁, 12₂, . . . , 12_{N}, e.g., N lasers, and an optical wavelength-multiplexer 14 to combine the light output by the single wavelength-channel, light sources 12₁-12_{N}. The optical output of the optical wavelength-multiplexer optically couples to one end of the optical transmission fiber 18, e.g., a standard single-mode optical fiber. The individual light source 12₁-12_{N} may be pumped, e.g., current pumped, in a manner that causes a desired wavelength-dependent intensity in the produced multi-wavelength-channel carrier light, e.g., a wavelength-dependent intensity pre-compensation.

Herein, carrier light is either unmodulated or modulated at a rate that is, at least, orders of magnitude lower than a symbol rate of subsequent modulation thereof.

In some embodiments, the multi-wavelength optical source 12 may optionally include an optical amplifier 16, e.g., an erbium-doped-fiber optical amplifier. The optical amplifier optically pre-amplifies the carrier light of the set of N wavelength-channels λ₁-λ_{N}, as received from the optical wavelength-multiplexer 14, i.e., prior to transmission of said multiple wavelength-channel, carrier light to the optical transmission fiber 18. A suitable wavelength-dependent pre-compensation of said carrier light may substantially improve the power efficiency of the optical amplifier 16. For example, the inventor believes that a suitable pre-compensation may improve the wall plug power efficiencies of some forms of the optical amplifier 16 to greater than 10 percent and possibly to even greater than 20 percent.

The array of optical data modulators 22₁-22_{N} is optically coupled to receive light from the multi-wavelength optical source 12 from the other end of the optical transmission fiber 18 via an optical wavelength-demultiplexer 20. In particular, each optical data modulator 22₁-22_{N} is optically coupled to an optical output of the optical wavelength-demultiplexer 20, which corresponds to one of the wavelength-channels λ₁-λ_{N}. The light of the wavelength-channels λ₁-λ_{N} X_{N} is optical carrier light, onto which, the optical data modulators 22₁-22_{N} are configured to modulate data streams for optical transmission therefrom. That is, each optical data modulator 22₁-22_{N} data-modulates received carrier light of a corresponding one of the wavelength-channels λ₁-λ_{N}. The centralized multi-wavelength optical source 12 provides the carrier light for the array of N individual optical data modulators 22₁-22_{N}, e.g., to modulate N independent data streams on the N different wavelength-channels thereof.

As illustrated in FIG. 1, the WDM optical fiber communication system 10 may be configured to support WDM optical communications between the array of N optical data modulators 22₁-22_{N} and an array of N optical data receivers 30₁, 30₂, . . . , 30_{N}, e.g., point-to-point communications. In such embodiments, an optical wavelength-multiplexer 24 combines the data-modulated light of the different wavelength-channels from the array of optical data modulators 22₁-22_{N} and transmits said WDM data-modulated light to an optical transmission fiber 26, e.g., another standard single-mode optical fiber. The array of optical data receivers 30₁-30_{N} receives the WDM data-modulated light from the optical transmission fiber 26 via an optical wavelength-demultiplexer 28. In particular, each optical data receiver 30₁-30_{N} receives data-modulated light of a single corresponding one of the wavelength-channels λ₁-λ_{N}, from which to recover or demodulate a data stream.

The WDM communication system 10 has several optical components that typically cause wavelength-dependent intensity filtering of light therein. For example, the optical wavelength-multiplexers 14, 24; the optical wavelength-demultiplexers 20, 28; and the optical amplifier 16 can all cause wavelength-dependent intensity filtering and wavelength dependent gain. For example, the optical amplifier 16 can also have a wavelength-dependent optical gain spectrum. For these reasons, the WDM light can have a different wavelength-dependent intensity at the input to the optical transmission fiber 18, and at the array of optical data receivers 30₁-30_{N}. At the array of optical data receivers 30₁-30_{N} such a wavelength-dependent passive and/or active optical intensity filtering could be problematic in the absence of some type of compensation.

The WDM communication system 10 may be advantageously configured to, at least, partially pre-compensate such an accumulation of wavelength-dependent attenuation due to transmission of said WDM carrier light between the multi-wavelength optical source 12 and the array of optical data receivers 30₁-30_{N} .

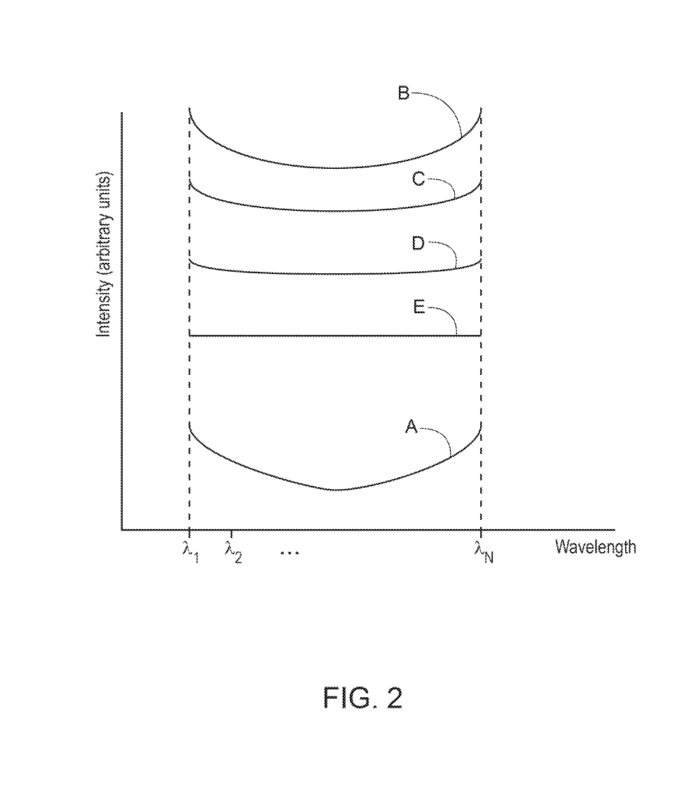

FIG. 2 schematically illustrates one example of how the wavelength-dependence of the intensity across the series of N wavelength-channels of such light may vary, e.g., over the WDM optical fiber communication system 10 of FIG. 1. In FIG. 2, the different curves A, B, C, D, and E schematically illustrate the dependence of the intensity as a function of wavelength-channel λ₁-λ_{N} at the corresponding points A, B, C, D, and E shown in FIG. 1. Due to the wavelength-dependent intensity pre-compensation, the intensity would typically be expected to be more wavelength-dependent at the array of lasers 12₁-12_{N}, i.e., point A, and at the input end of the optical transmission fiber 18, i.e., point B, than at the intermediate points C and D along the optical paths to the array of optical data receivers 30₁-30_{N}. Indeed, at the array of optical data receivers 30₁-30_{N}, it may be desirable to have a substantially wavelength-flat or wavelength-flat intensity spectrum so that various ones of the optical data receivers 30₁-30_{N} can typically function similarly with similar bit error rates, e.g., for amplitude modulation formats.

For example, the time-averaged intensity of received light may desirably vary, in a wavelength-dependent manner, over the array of optical data receivers 30₁-30_{N} by less than about 3 decibels, by less than about 2 decibels, or even by less than about 1 decibel. In such a situation, the different optical data receivers 30₁-30_{N} are more likely to have similar bit error rates during the demodulation of data from the different received data-modulated optical carriers without a need for substantial individualization of said optical data receivers 30₁-30_{N} or with a need of less complex individualization thereof.

In various embodiments, the wavelength-dependence of the intensity of the light received at the array of optical data receivers 30₁-30_{N} may be less than for the multi-wavelength light transmitted to the optical transmission fiber 18 by the multi-wavelength optical source 12. Herein, the embodiments are meant to cover apparatus and methods for pre-compensation of wavelength-dependent intensities to reduce various quantitative measures of such wavelength-dependency for the light intensity at the array of optical data receivers 30₁-30_{N} as compared to the wavelength-dependency of the intensity of the light transmitted to the input end of the optical transmission fiber 18.

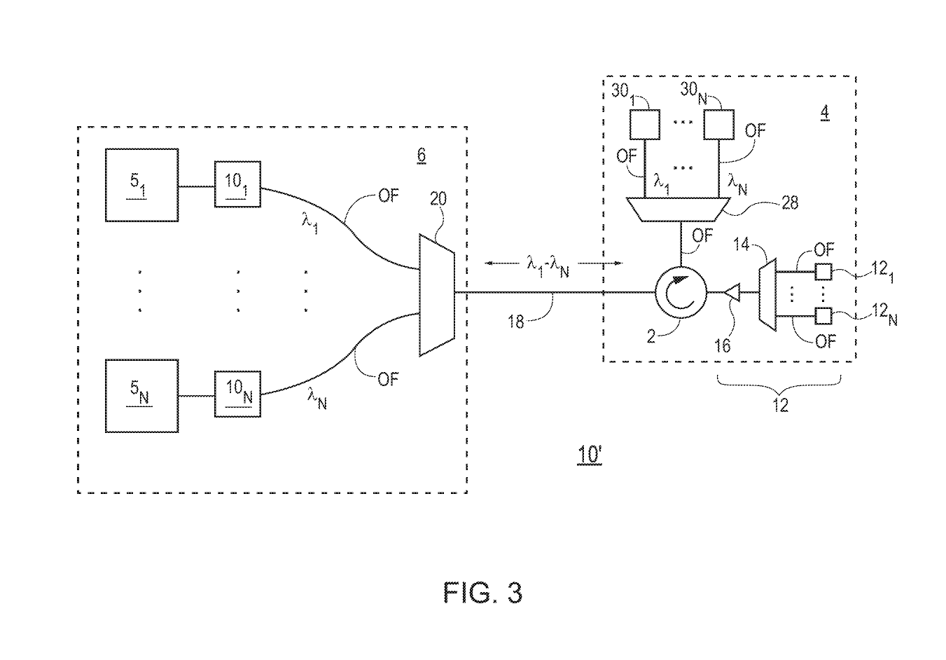

FIG. 3 illustrates an alternate WDM optical fiber communication system 10′ having a centralized multi-wavelength optical source 12. The system 10′ is based on the array of optical data modulators 10₁, . . . , 10_{N} being an array of N reflective optical data modulators, e.g., reflective electro-absorption modulators. In the WDM optical fiber communication system 10′, the array of N optical data modulators 10₁-10_{N}; the multi-wavelength optical source 12: the array of N optical data receivers 30₁, . . . , 30_{N}; the optical wavelength-demultiplexers 20, 28; and the optical transmission fiber 18 may be configured to function as already described with respect to FIG. 1. But, in FIG. 3, the optical wavelength-demultiplexer 20 also functions as the optical wavelength-multiplexer 24 of FIG. 1, and the optical transmission fiber 18 also functions as the optical transmission fiber 26 of FIG. 1, because the optical data modulators 10₁-10_{N} are back reflecting optical devices, which are configured to transmit data-modulated light back into the same optical fibers (OF) and the same ports of the optical wavelength-demultiplexer 20 from which unmodulated carrier light is received.

The optical communication system 10′ also includes an optical rotator 2, which operates to separately route data-modulated and data-unmodulated light in location 4. In particular, the optical rotator 2 directs unmodulated or substantially unmodulated light of the N optical wavelength channels λ₁-λ_{N} from the optical comb source 12 to the optical transmission fiber 18, for transmission to the location 6. Also, the optical rotator 2 directs data-modulated light on the N optical wavelength-channels received from the remote location 6, i.e., via the optical transmission fiber 18, to the input of the optical wavelength-demultiplexer 28 via another optical fiber OF.

FIG. 3 also illustrates electronic devices 5₁, . . . , 5_{N} for operating the individual optical data modulators 10₁-10_{N} at location 6. Each electronic device 5₁-5_{N} may also, e.g., have an interface to a corresponding digital data server, at location 6, in an embodiment of a WDM optical fiber communication system inside a data center. For example, each electronic device 5₁-5_{N} may receive a digital data stream from a corresponding digital data server for reflective modulation onto an optical carrier of a corresponding wavelength-channel λ₁-λ_{N} in a corresponding one of the optical data modulators 10₁-10_{N}.

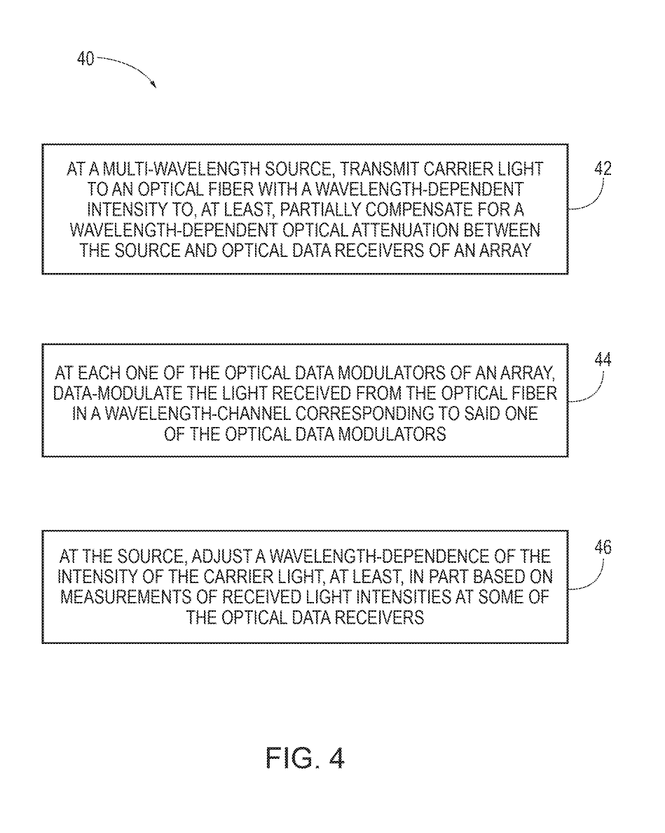

FIG. 4 illustrates a method 40 for optical fiber communication based on a multi-wavelength optical source for carrier light, e.g., the multi-wavelength optical source 12 of either of FIGS. 1 and 3.

The method 40 includes, at a multi-wavelength optical source, transmitting to an optical transmission fiber carrier light with a wavelength-dependent, intensity to substantially pre-compensate or , at least, to partially pre-compensate for wavelength-dependent optical attenuation between the multi-wavelength optical source and optical data receivers of an array (step 42). For example, the optical source may be the optical source 12 of FIG. 1 or 3, and the array may be the remote or near arrays of the optical data receivers 30₁-30_{N} of FIG. 1 or 3. Each one of said optical data receivers is connected via the same optical transmission fiber to receive some light of a corresponding one of the wavelength-channels of said transmitted light. The wavelength-dependent optical attenuation may result from optical attenuation or from optical amplification combined with optical attenuation between the optical source and the optical data receivers.

The method may further include, at each one of the optical data modulators of an array, e.g., at the optical data modulators 10₁-10_{N} of FIG. 1 or 3, data-modulating light received from the optical transmission fiber in the one of the wavelength-channels corresponding to said one of the optical data modulators (step 44). The optical data modulators of this array are optically coupled to receive light from said multi-wavelength optical source via the same optical transmission fiber, e.g., the optical transmission fiber 18 of FIG. 1 or 3.

Typically, each of the N optical data receivers is optically coupled to receive a portion of the data-modulated light from a different corresponding one of the optical data modulators of the array. The array of optical data modulators is connected to transmit the data-modulated light to the same optical fiber for transmission to the corresponding optical data receivers.

The method 40 may further include, at the multi-wavelength optical source, adjusting a wavelength-dependency of the intensity of the transmitted carrier light, at least, in part based on measurements of intensities of received light at some of the optical data receivers (step 46). The measurements may characterize a wavelength-dependency of said received light over the array of optical receivers, e.g., as measured by separate optical intensity monitors or optical data detectors in the optical data receivers or by a received signal strength indicator (RSSI) typically incorporated into the electronic amplifier connecter to a high-speed receiver photodiode. The wavelength dependency may also be characterized by a measurement of photocurrent generated in the modulators of the multi-wavelength transmitter if a modulation approach such as electro-absorption or another effect that generates a photocurrent sufficient to measure the differential optical wavelength strengths. The information about the required pre-compensation can be returned to the start of the transmission link by multiple methods but preferentially by back propagation as low speed tone modulation outside the optical data bandwidth. At the multi-wavelength optical source, the wavelength-dependency may also be partially preset based on known characteristics of the WDM optical fiber communication system. Such feedback adjustment may be made, e.g., to substantially or partially compensate for wavelength-dependent optical attenuation between the optical source and the array of optical data receivers. Pre-compensation may not achieve a fully optimized spectrum shaping or overall efficiency but does not necessarily require an added back propagation channel, e.g., for measurements from optical data receivers or an optical amplifier.

In any of the embodiments of the method 40, the wavelength-dependent intensity of the WDM carrier light, transmitted from the multi-wavelength optical source, may be largest for one of the wavelength-channels near an edge of an interval including the sequence of optical wavelength-channels.

In any of the embodiments of the method 40, the wavelength-dependent intensity of the WDM carrier light, transmitted from the multi-wavelength optical source, may have maxima in wavelength-channels near both edges of an interval including the sequence of wavelength-channels.

The Detailed Description of the Illustrative Embodiments and drawings merely illustrate principles of the inventions. Based on the present specification, those of ordinary skill in the relevant art will be able to devise various arrangements that, although not explicitly described or shown herein, embody the inventions and are included within the scope of the claims. Also, statements herein reciting principles, aspects, and embodiments are intended to encompass equivalents thereof.

What is claimed is:

1. An apparatus, comprising:
an optical source to produce light in a sequence of wavelength-channels;
an optical transmission fiber connected to receive said produced light;
an optical wavelength-demultiplexer optically coupled to the optical transmission fiber;
an array of optical data modulators, each of the optical data modulators being optically coupled to receive light of a corresponding one of the wavelength-channels from the optical source via the optical transmission fiber and the optical wavelength-demultiplexer; and
wherein the optical source is configured to transmit said light to said optical transmission fiber with a wavelength-dependent intensity.

2. The apparatus of claim 1, wherein the wavelength-dependent intensity is largest for one of the wavelength-channels near an edge of a wavelength range for the sequence of wavelength-channels.

3. The apparatus of claim 2, wherein the wavelength-dependent intensity is largest for wavelength-channels near both edges of the wavelength range.

4. The apparatus of claim 1, further comprising an array of optical data receivers; and
wherein an optical fiber optically couples to the array of optical data receivers via a second optical wavelength-demultiplexer and optically couples to the array of optical data modulators via an optical wavelength-multiplexer.

5. The apparatus of claim 4, wherein the optical fiber coupled to the array of optical data receivers via the second optical wavelength-demultiplexer is the optical transmission fiber.

6. The apparatus of claim 4, wherein the optical source is configured to, at least, partially, pre-compensate for wavelength-dependent optical attenuation between the optical source and the array of optical data receivers.

7. The apparatus of claim 6, wherein the light received at the array of optical data receivers has a substantially flat wavelength-channel-dependent intensity.

8. The apparatus of claim 2, wherein the optical source includes an array of lasers optically connected to inputs of an optical wavelength-multiplexer; and
wherein each of the lasers is configured to produce light of a different one of the wavelength-channels; and
wherein different ones of the lasers are configured to be driven such that, at an output of the optical wavelength-multiplexer, light of wavelength-channels near outer boundaries of the sequence having a higher intensity than light of wavelength-channels away from the outer boundaries.

9. The apparatus of claim 4, wherein the apparatus is a wavelength division multiplexing, optical communication system communicatively connected to digital data servers inside a data center.

10. The apparatus of claim 8, further comprising an optical amplifier connected to amplify light output light from the array of lasers and to transmit said amplified light to the optical transmission fiber with a wall plug power efficiency of greater than 10 percent.

11. The apparatus of claim 8, further comprising an optical amplifier connected to amplify light output light from the array of lasers and to transmit said amplified light to the optical transmission fiber with a wall plug power efficiency of greater than 20 percent.

12. The apparatus of claim 1, further comprising an optical amplifier located to amplify light output from the optical source and transmit said amplified light to the optical transmission fiber with a wall plug power efficiency of greater than 10 percent.

13. The apparatus of claim 1, further comprising an optical amplifier located to amplify light output from the optical source and transmit said amplified light to the optical transmission fiber with a wall plug power efficiency of greater than 10 percent.

14. The apparatus of claim 1, wherein optical data modulators are configured to transmit data-modulated light to the optical transmission fiber.

15. A method, comprising:
from a multi-wavelength optical source, transmitting to an optical transmission fiber light with a wavelength-dependent intensity to, at least, partially compensate for a wavelength-dependent optical attenuation due to propagation of the light between the multi-wavelength optical source and optical data receivers of an array; and
wherein each of said optical data receivers is connected via the optical transmission fiber to receive some light of a corresponding wavelength-channel of said transmitted light.

16. The method of claim 15, further comprising:
at each one of a plurality of optical data modulators, data modulating light received from the multi-wavelength optical source in a wavelength-channel corresponding to said one of the optical data modulators; and
wherein the optical data modulators of the plurality are connected to receive light from said multi-wavelength optical source via a same optical fiber.

17. The method of claim 15, wherein each of said optical data receivers is connected to receive a portion of the data modulated light from a different corresponding one of the optical modulators; and
wherein the array of optical modulators is optically coupled to transmit the data modulated light to a same optical fiber.

18. The method of claim 17, further comprising, at the optical source, adjusting a wavelength dependence of the intensity of said transmitted light, at least, in part based on measurements of light intensities at some of the optical data receivers.

19. The method of claim 15, wherein the wavelength-dependent intensity of the transmitted light is largest for one of the wavelength-channels near an edge of an interval including the sequence of wavelength-channels.

20. The method of claim 15, wherein the wavelength-dependent intensity of the transmitted light has maxima in the wavelength-channels near both edges of an interval including the sequence of wavelength-channels.
